(19) United States
(12) Patent Application Publication
(10) Pub. No.: US 2011/0284602 A1
(43) Pub. Date: Nov. 24, 2011

(54) LIFTING TRUCK MOUNTED TOOLBOXES

(76) Inventor: Timmie Wayne Lamouroux, Cobb Island, MD (US)

(21) Appl. No.: 13/017,006

(22) Filed: Jan. 30, 2011

Related U.S. Application Data
(60) Provisional application No. 61/299,716, filed on Jan. 29, 2010.

(51) Int. Cl. B60R 9/00

(52) U.S. Cl. 224/402

(57) ABSTRACT

A tool box laterally mountable in a pick up truck is provided that includes at least one lifting mechanism that lifts the toolbox vertically in between a first lowered position and at least one lifted position. In the lowed position the tool box occupies a portion of a length of a bed of the pick up truck and in the lifted position recaptures at least a portion of the length of the bed of the pick up truck.

The present application claims priority to U.S. Provisional Patent Application No. 61/299,716, filed Jan. 29, 2010.

### BACKGROUND OF THE INVENTION

The present application relates to tool boxes and more particularly to truck mounted toolboxes.

Truck mounted tool boxes are fairly popular. One of the most popular types is a tool box mounted laterally in the bed of a pickup truck. These types of tool boxes are typically mounted in a fixed arrangement in the bed of the truck near the truck cab. As a result, the tool box shortens the useful length of the bed of the truck. Accordingly, there is a need for tool boxes that do not have this or other limitations.

### SUMMARY OF THE INVENTION

In at least one embodiment, a tool box laterally mountable in a pick up truck, is provided that includes at least one lifting mechanism that lifts the toolbox vertically in between a first lowered position and at least one lifted position, in the lowed position the tool box occupies a portion of a length of a bed of the pick up truck and in the lifted position recaptures at least a portion of the length of the bed of the pick up truck.

### BRIEF DESCRIPTION OF THE FIGURES

FIG. 1 is a perspective view showing a lifting tool box according to one embodiment of the tool boxes discussed herein in a pick up truck in a lowered position.

FIG. 2 is a perspective view showing a lifting tool box according to one embodiment of the tool boxes discussed herein in a pick up truck in a lifted position.

FIG. 3 is a side view of a lifting tool box according to one embodiment of the tool boxes discussed herein.

FIG. 4 is a top view of a lifting tool box according to one embodiment of the tool boxes discussed herein.

FIG. 5 is a side view of a motor assembly for lifting the tool box according to one embodiment of the tool boxes discussed herein.

FIG. 6 is a detail of a slide assembly for lifting the tool box according to one embodiment of the tool boxes discussed herein.

FIG. 7 is a top view showing a lifting tool box according to one embodiment of the tool boxes discussed herein in a pick up truck.

FIG. 8 is a side view showing a lifting tool box according to one embodiment of the tool boxes discussed herein in a pick up truck in a lowered position.

FIG. 9 is a perspective view showing a lifting tool box according to one embodiment of the tool boxes discussed herein in a pick up truck in a lifted position.

### DETAILED DESCRIPTION OF THE INVENTION

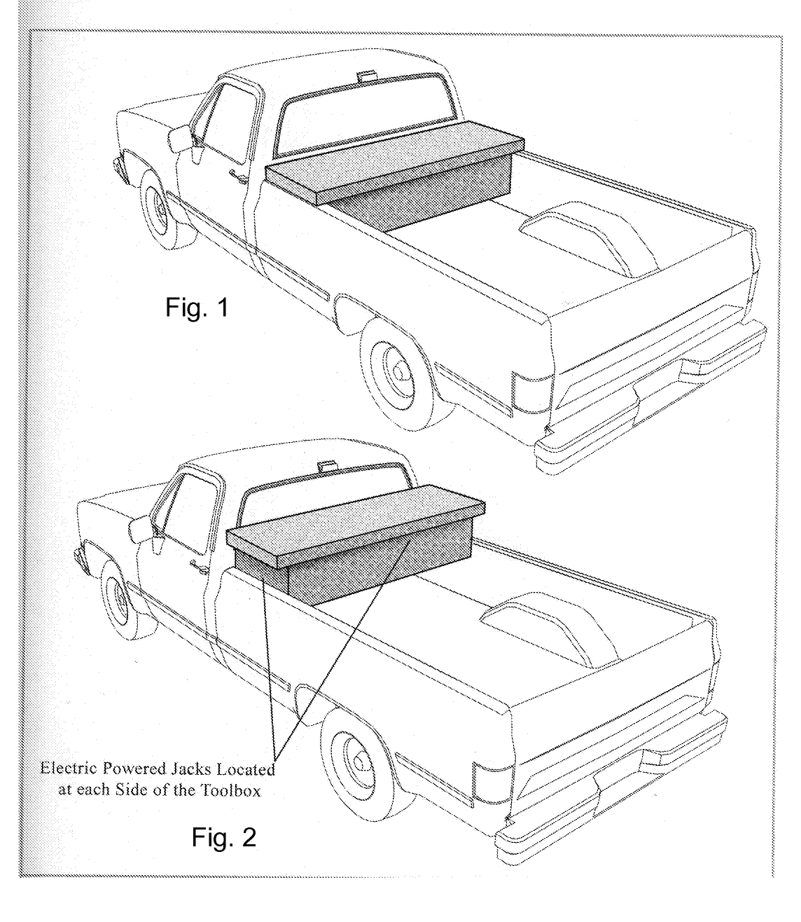

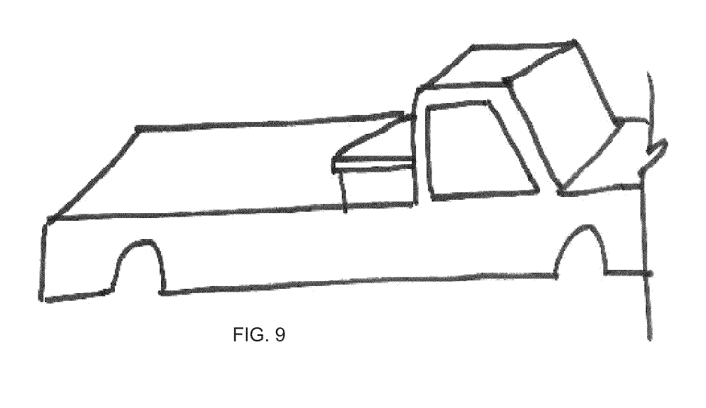

Referring to FIG. 1, in one embodiment, the tool box is mountable in the bed of a pickup truck laterally from the left to the right side of the bed near the cab of the truck. The tool box preferably includes at least one lifting mechanism that lifts the toolbox vertically as shown in FIG. 2. The vertical lift is also shown in FIG. 8 in an extended position and in FIG. 9 in a lowered position. In this respect, the tool box may be moved high enough vertically to recapture the length of the bed that may have otherwise been lost by a tool box fixed to the bed.

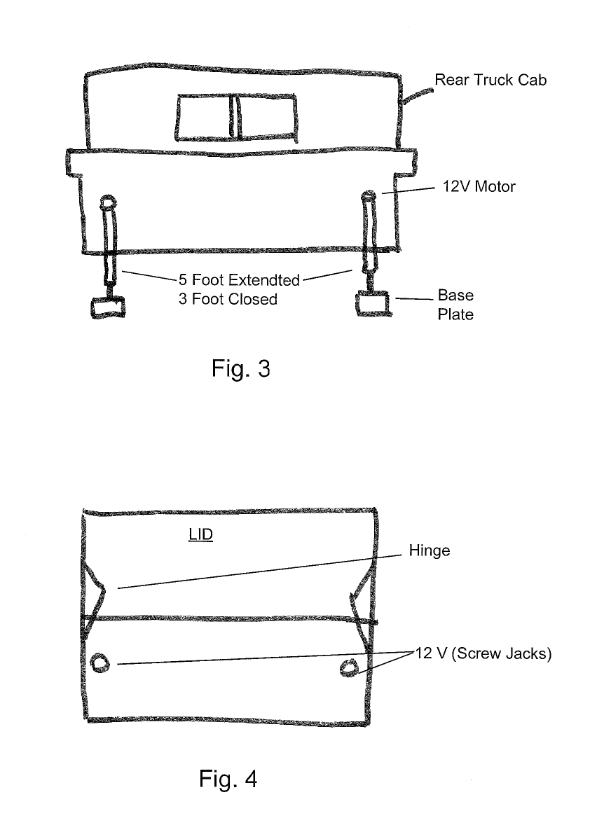

It is understood that the vertical lift may be achieved in a variety of ways. Referring to FIG. 3, in one embodiment, the vertical lift is accomplished with a plurality of struts disposed on either lateral end of the tool box. The top end of the strut is mounted to an interior side of the tool box while the opposite end comes into contact with the truck bed. A base plate may be installed at the bottom end of the strut to spread the weight of the box on the truck bed. The strut is preferably power actuated to lift the tool box vertically. In one embodiment, the strut is a screw type lifting mechanism that is powered by a 12 volt motor. In operations, the length of the strut is extended and shorted by unscrewing and screwing a threaded rod and/or a corresponding threaded sleeve. The strut passes through a hole in the bottom end of the tool box as shown in FIGS. 3 and 4.

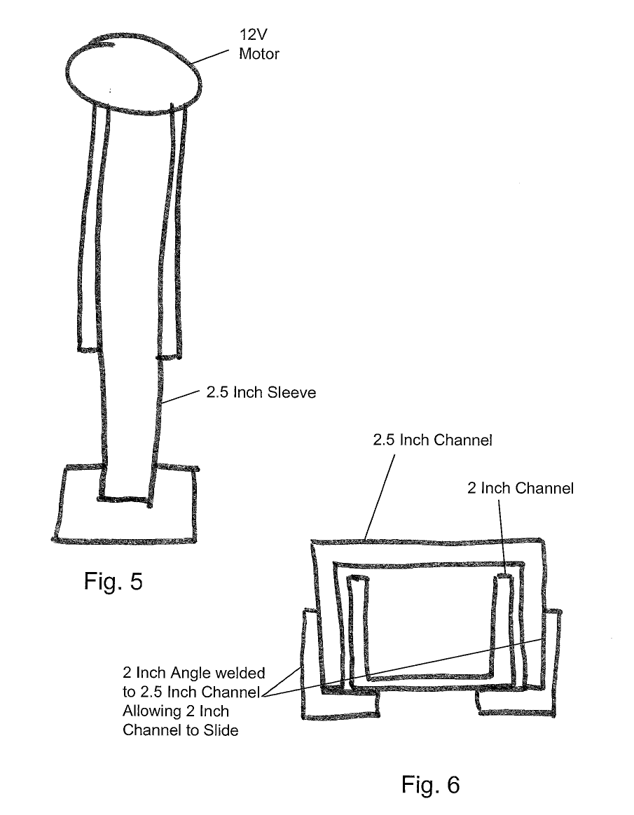

Referring to FIG. 5, the strut may be powered by a 12 volt motor that is disposed on the top end of the strut to operate the threaded rod and/or sleeve. Other types of actuation may be used, including hydraulic and pneumatic actuators.

Referring to FIG. 6, the toolbox is preferably mounted to the bed of the truck in such a way the lateral and longitudinal movement is constrained while allowing vertical movement. This may be accomplished with a telescoping mount that extends vertically at least the same amount as the strut. The telescoping relationship may be achieved with an inner member (the channel) disposed within an outer tubular member (a combination of a channel and a pair of angles). Although shown with multiple components, the tubular member may be made from a single rectangular tube with a lengthwise opening therein that allows bolts extending from the inner member to move within the opening.

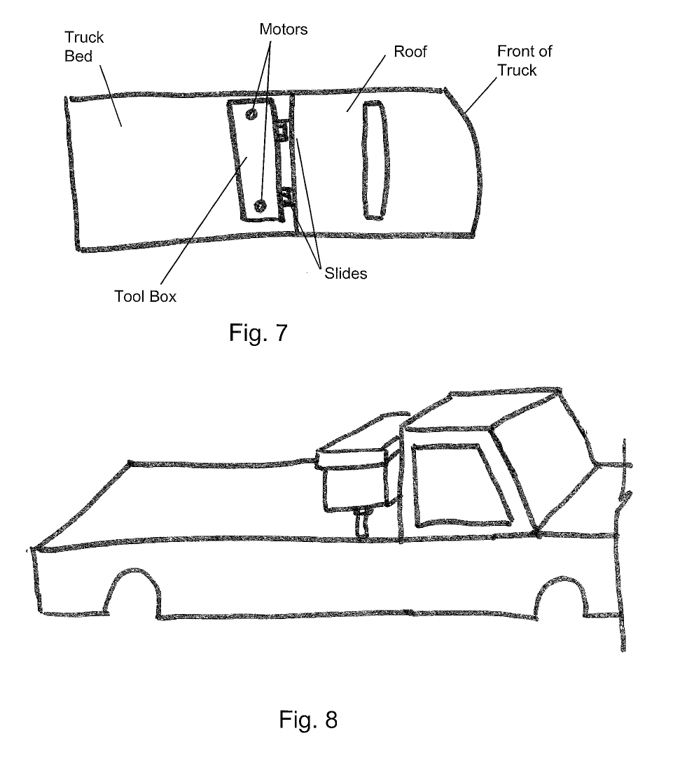

The telescoping mounts may be mounted on the end of the bed near the truck cab. That is, the outer member may be bolted or welded to the vertical sidewall of the bed that abuts the cab while the inner member bolts or is welded to the outside of the tool box, as shown in FIG. 7.

While the foregoing invention has been described in some detail for purposes of clarity and understanding, it will be appreciated by one skilled in the art, from a reading of the disclosure, that various changes in form and detail can be made without departing from the true scope of the invention in the appended claims.

What is claimed is:

1. A tool box laterally mountable in a pick up truck, the tool box comprising at least one lifting mechanism that lifts the toolbox vertically in between a first lowered position and at least one lifted position, in the lowed position the tool box occupies a portion of a length of a bed of the pick up truck and in the lifted position recaptures at least a portion of the length of the bed of the pick up truck.
